(19) United States
(12) Patent Application Publication
(10) Pub. No.: US 2025/0217438 A1
(43) Pub. Date: Jul. 3, 2025

(54) RVV1.0 Extension-Based FFT Butterfly Operation Method for Complex Sequences

(71) Applicant: Jiangsu Huachuang Microsystem Company Limited, Nanjing (CN)

(72) Inventors: Haibin ZHOU, Nanjing (CN); Shiping LI, Nanjing (CN); Wenjun HAN, Nanjing (CN)

(73) Assignee: Jiangsu Huachuang Microsystem Company Limited, Nanjing (CN)

(21) Appl. No.: 19/002,782

(22) Filed: Dec. 27, 2024

(30) Foreign Application Priority Data
Dec. 27, 2023 (CN) 202311813619.X

(51) Int. Cl. G06F 17/14

(52) U.S. Cl. CPC G06F 17/142

(57) ABSTRACT

An RVV1.0 extension-based FFT butterfly operation method for complex sequences includes the following steps: S1, in one stage of an FFT butterfly operation, acquiring data to be processed; S2, based on a standard vector structure of RVV1.0, defining an extended instruction I in a reserved instruction code space of an RISC-V architecture to obtain first data of a multiply-add operation; S3, defining an extended instruction II to obtain second data of the multiply-add operation, and adding the second data and the first data to obtain a multiply-add operation result; S4, defining an extended instruction III to obtain a multiply-subtract operation result; S5, storing a result in a vector register as an operation result of the stage; and S6, if there is a next stage, performing the next stage, and returning to S1; or, if there is not a next stage, ending the FFT butterfly operation.

### CROSS REFERENCE TO THE RELATED APPLICATIONS

This application is based upon and claims priority to Chinese Patent Application No. 202311813619.X, filed on Dec. 27, 2023, the entire contents of which are incorporated herein by reference.

### TECHNICAL FIELD

The invention relates to the field of computer instructions, in particular to an RISC-V Vector v1.0 (RVV1.0) extension-based Fast Fourier Transform (FFT) butterfly operation method for complex sequences.

### BACKGROUND

Reduced Instruction Set Computing—Version Five (RISC-V) is a fifth-generation computer reduced instruction set architecture standard that was established by the University of California, Berkeley in 2010, and the establishment and ecological construction of this standard are dominated by the RISC-V international foundation. RISC-V has a simple instruction system, is completely open and adopts a modular design, thus being applicable to servers, desktops as well as embedded and other fields and having a broad market prospect. The RISC-V international foundation officially released, in May 2021, a first version of RISC-V instruction set, including integer and floating-point scalar instructions, and released, in September 2021, an RISC-V Vector v1.0 (RVV1.0) extension, laying a foundation for the access of RISC-V to high-end processor markets. RVV1.0 includes eight types, over 400 in total, vector instructions, 32 vector registers and 7 non-privileged control and status registers, wherein over 90 instructions are vector floating-point operational instructions, which satisfy the requirements for conventional floating-point operations in typical application scenarios.

To guarantee the universality of the instruction set, RVV1.0 only support vectorization of the four fundamental operations and does not define instructions related to the hierarchy of digital signal processing algorithms, thus being suitable only for real sequence operations and not suitable for complex sequence operations. Functions defined by the RVV1.0 instruction set does not match data scheduling and operation rules realized by specific signal processing algorithms, so multiple instruction combinations have to be used to implement such signal processing algorithms, compromising the performance of these signal processing algorithms. Fast Fourier transform (FFT), as a classic algorithm for realizing time domain-frequency domain transform in signal processing, is widely applied to spectral analysis, digital filtering, signal compression, fast convolution and other real-time signal processing fields. The data format of FFT is generally single-precision floating-point complex sequences, and the basic operator is an FFT butterfly operation including multiple multiply-add operations of complex numbers. The FFT algorithm can be broken up into multiple stages of butterfly operations, and data in butterfly operations at the same stage are irrelevant, so the FFT algorithm have a high degree of parallelism and is suitable for vector operations to improve processing performance.

With a radix-2 DIT FFT butterfly operation of complex sequence as an example, the operation relation illustrated by formula (1) in FIG. 3, where A, B and W are three complex sequences, A′ is the result of a multiply-add operation, and B′ is the result of a multiply-subtract operation. Because the RVV1.0 vector extension does not support complex sequence operations, a complex sequence operation needs to be broken up into real sequence operations, and then a vector real sequence instruction is used to implement the butterfly operation. It can be known from formula (1) that one radix-2 DIT FFT butterfly operation of complex sequences includes four real-number multiply-add/subtract operations as well as two vector and scalar floating-point multiply-subtract operations. When such an operation is implemented by the RVV1.0 basic instruction set, instructions involved at least include vector floating-point multiply-add instructions (vfmacc.vv), vector floating-point multiply-subtract instructions (vfnmsac.vv) as well as vector and scalar floating-point multiply-subtract instructions (vfmsac.vf). Wherein, a real part of A′ is completed by means of a vector floating-point multiply-add (vfmacc.vv) instruction and a vector floating-point multiply-subtract (vfnmsac.vv) instruction, an imaginary part of A′ is completed by means of two vector floating-point multiply-add (vfmacc.vv) instructions, and a real part and an imaginary part of B′ are respectively completed by means of a vector and scalar floating-point multiply-subtract (vfmsac.vf) instruction. Generally, when the bit width of vector registers is 256, eight radix-2 FFT butterfly operations can be completed based on the RVV1.0 instruction set by means of six vector real sequence operation instructions and other non-operation instructions using eight vector registers (wherein, two for each of the real part and the imaginary part of A, and one for each of the real part and the imaginary part of B and for each of the real part and the imaginary part of W) and one floating-point register, that is, one radix-2 FFT butterfly operation can be implemented on average by means of 0.75 vector operation instruction, thus fulfilling high operation performance.

A single-precision floating-point real sequence multiply-add instruction of RVV1.0 is in a format: vfmacc.vv vd, vs1, vs2, vm, and functions for:

for( i=0; i< vlen; i++) {
vd[i] ← vd[i] + (vs1[i] * vs2[i])
}

where, vlen is a vector length, and if the bit width of vector registers is N and the data type is single-precision floating point, vlen is N/32. Therefore, in the aspect of hardware operation logic resources, N/32 floating-point multipliers and adders are needed in total to complete the real sequence multiply-add operation of one vfmacc.vv instruction. A real sequence multiply-subtract instruction of RVV1.0 is in a format: vfnmacc.vv vd, vs1, vs2, vm, and is similar to the real sequence multiply-add instruction vfmacc.vv in function and hardware logic except that subtraction rather than addition is implemented by the instruction and a group of subtracters rather than adders are used.

However, because the RVV1.0 vector set does not support complex sequence operations, the complex sequence operation has to be broken up into real sequence operations, and then a vector real sequence instruction is used to indirectly complete a butterfly operation, so the process is complex, and the arithmetic speed is compromised; in addition, the real part and imaginary part of each complex number in the butterfly operation need to be stored separately, but actually, the complex numbers are stored in a memory in the form of a complex sequence with addresses of the real parts and imaginary parts of the complex numbers being interleaved, so extra hardware logic resources have to be configured for storage, increasing the overhead.

### SUMMARY

The objective of the invention is to provide an RVV1.0 extension-based FFT butterfly operation method for complex sequences, which defines three extended instructions that support an FFT butterfly operation of complex sequences to directly implement the FFT butterfly operation of the complex sequences and eliminates a step of breaking complex sequences up into real sequences, thus increasing the arithmetic speed; in addition, data are stored with real parts and imaginary parts being interleaved, such that extra hardware logic resources do not need to be configured, thus reducing the overhead.

The technical solution adopted by the invention is as follows:

An RVV1.0 extension-based FFT butterfly operation method for complex sequences, the method including the following steps:
S1, in one stage of an FFT butterfly operation of complex sequences, acquiring data to be processed;
S2, based on a standard vector structure of RVV1.0, defining a single-precision floating-point real sequence multiply-add extended instruction I in a reserved instruction code space of an RISC-V architecture to perform a multiply-add operation on the data to be processed in S1 to obtain first data;
S3, based on the standard vector structure of RVV1.0, defining a single-precision floating-point complex sequence multiply-add extended instruction II in the reserved instruction code space of the RISC-V architecture to perform a multiply-add operation on the data to be processed in S1 to obtain second data, and adding the second data and the first data obtained in S2 to obtain a multiply-add operation result of the data to be processed;
S4, based on the standard vector structure of RVV1.0, defining an immediate value vector and scalar floating-point multiply-subtract extended instruction III in the reserved instruction code space of the RISC-V architecture to perform a multiply-subtract operation on the multiply-add operation result in S3 to obtain a multiply-subtract operation result of the data to be processed;
S5, adding the multiply-add operation result obtained in S3 and the multiply-subtract operation result obtained in S4, and storing data obtained by adding the multiply-add operation result and the multiply-subtract operation result in a vector register as an operation result of the stage; and
S6, after the operation result of one stage is obtained, performing a next stage, and returning to S1 to repeat the steps until all stages of the FFT butterfly operation of the complex sequences are completed.

A multiply-add operation result of each stage of a butterfly operation can be directly obtained by means of two single-precision floating-point complex sequence multiply-add extended instructions (I) and (II), and a step of breaking data up into real sequences for preprocessing is eliminated; then, a multiply-subtract operation result of each stage of the butterfly operation is directly obtained by means of an immediate value vector and scalar floating-point multiply-subtract extended instruction III; the two results are added to obtain a butterfly operation result that is stored in a vector register, and the step of configuring extra hardware logic resources is eliminated, such that the butterfly operation result of one stage can be obtained quickly, the operation speed is high, the hardware logic resource overhead is reduced, and the processing performance is improved.

Preferably, in S1, a method for acquiring the data to be processed includes:
(1) in a case where there is a previous stage, operation results in the previous stage are used as the data to be processed;
(2) in a case where there is not a previous stage, data of the complex sequences are loaded into vector registers by means of vector load instructions to be used as the data to be processed.

An FFT butterfly operation is divided into at least two stages; input data are operated in a first stage, and operation results of the previous stage are used as input data in the next stage to perform further operations until all stages are completed. Data are stored in vector registers by means of vector load instructions, such that the data can be processed easily, extra processing of the data is not needed, and data processing is convenient.

Preferably, in S2-S4, when the extended instructions I, II and III are defined, a same operational code is selected for the three extended instructions. By selecting the same operational code for the three instructions, the number of instructions can be reduced, and the hardware design can be simplified, thus the improving instruction execution efficiency to complete an execution task more quickly.

Preferably, in S5, the data obtained by adding the multiply-add operation result and the multiply-subtract operation result are stored in the vector register in a form that real parts and imaginary parts of the data interleaved.

Data are stored in a vector register with real parts and imaginary parts being interleaved, such that data storage is efficient and fast, and the complex step of storing the real parts and the imaginary parts separately is eliminated.

Compared with the prior art, the invention has the following beneficial effects:

According to the invention, a multiply-add operation of complex sequences is completed directly by means of two extended instructions, a multiply-subtract operation of the complex sequences is completed directly by means of another extended instructions, results of the two operations are directly stored in a vector register, the complex process of transforming the complex sequences into real sequences and then transforming the real sequences to the complex sequences is simplified, and no extra hardware logic resource needs to be configured, thus reducing overhead.

### BRIEF DESCRIPTION OF THE DRAWINGS

FIG. 1 is a flow diagram of an RVV1.0 extension-based FFT butterfly operation method for complex sequences according to one embodiment of the application;

FIG. 2 illustrates the code standard of arithmetic operation instructions of RVV1.0 according to one embodiment of the invention;

FIG. 3 illustrates an operational relation of a radix-2 DIT FFT butterfly operation of complex sequences according to one embodiment of the application.

### DETAILED DESCRIPTION OF THE EMBODIMENTS

The technical solutions in some embodiments of the invention are described in detail below in conjunction with drawings of these embodiments. Obviously, the embodiments in the following description are merely illustrative ones, and are not all possible ones of the invention. All other embodiments obtained by those ordinarily skilled in the art based on the following ones without creative labor should also fall within the protection scope of the invention.

All extended instructions in the invention are extended based on the standard vector structure of the RVV1.0 vector extension, and when extended, satisfy the following two parameter requirements: (1) elen: a maximum number of bits of a vector element generated or consumed by any operation, wherein elen≥8, and elen must be the power of 2; (2) vlen: the number of bits in one vector register, wherein vlen≥elen, and vlen must be the power of 2 and should not be greater than 2¹⁶. As required by RISC-V, vlen is less than 2¹⁶.

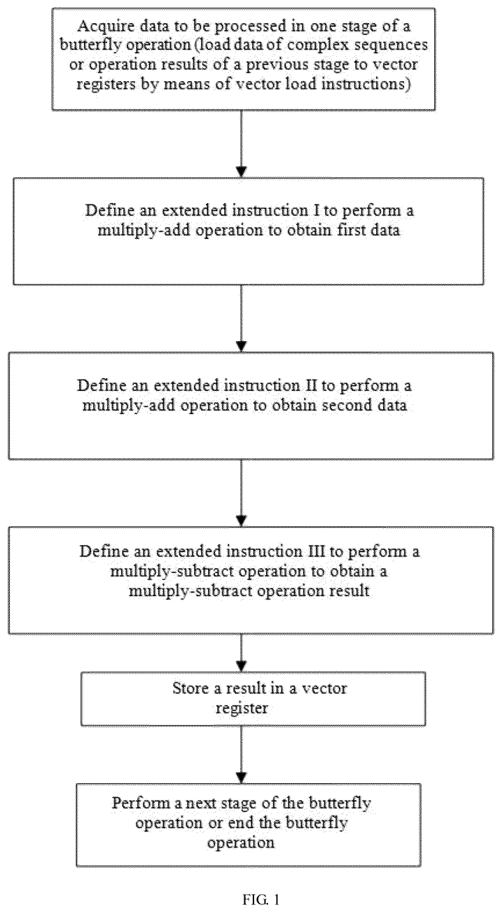

As shown in FIG. 1, this embodiment provides an RVV1.0 extension-based FFT butterfly operation method for complex sequences. In each stage of a butterfly operation, extended instructions are defined to directly reuse original resources of RVV1.0 to perform multiply-add or multiply-subtract operations, and operation results are stored in vector registers until operations in all stages are completed, such that the process is simple, the arithmetic speed is high, and no extra hardware logic resource needs to be configured.

The invention provides an RVV1.0 extension-based FFT butterfly operation method for complex sequences, including steps S1-S6.

S1: in one stage of an FFT butterfly operation of complex sequences, data to be processed are acquired.

It should be noted that the butterfly operation is a basic operation unit of the FFT algorithm; in a first stage of the butterfly operation, real parts and imaginary parts in complex sequences are combined and calculated respectively according to a rule, for example, the real parts and the imaginary parts are combined and calculated according to an odd-even rule to obtain an operation result of the first stage; then, in a second stage of the butterfly operation, the operation result of the first stage is processed, and the real parts and the imaginary parts in the complex sequences are combined and calculated according to the same rule to obtain a result of the second stage; and finally, the result of the second stage is stored in a vector register as a final operation result, and the butterfly operation is completed.

In S1, there are two cases for the acquisition of data to be processed in each stage: (1) in a case where there is a previous stage, operation results in the previous stage are used as the data to be processed; (2) in a case where there is not a previous stage, data of the complex sequences are loaded into vector registers by means of vector load instructions to be used as the data to be processed. In the FFT butterfly operation, the vector load instruction is used for loading data of complex sequences from a memory into a vector register to be used for subsequent vector calculation, such that the overhead for reading data from the memory is reduced, and the calculation efficiency is improved.

S2: based on a standard vector structure of RVV1.0, a single-precision floating-point real sequence multiply-add extended instruction I is defined in a reserved instruction code space of an RISC-V architecture to perform a first multiply-add operation on the data to be processed in S1 to obtain first data of the multiply-add operation of the data to be processed.

It should be noted that a code space for extended instructions is reserved in the RISC-V architecture, the extended instruction is defined in the code space. In addition, as described in the background art, the hardware logic of the single-precision floating-point real sequence multiply-add operation of RVV1.0 includes the code format, functional codes, etc. Therefore, in S2, the single-precision floating-point real sequence multiply-add extended instruction I is defined, and an RVV1.0 single-precision floating-point complex sequence multiply-add instruction is extended directly based on the hardware logic of the single-precision floating-point real sequence multiply-add operation of RVV1.0, such that original resources of RVV1.0 can be directly reused, the operation is fast and effective, and no extra resource needs to be configured.

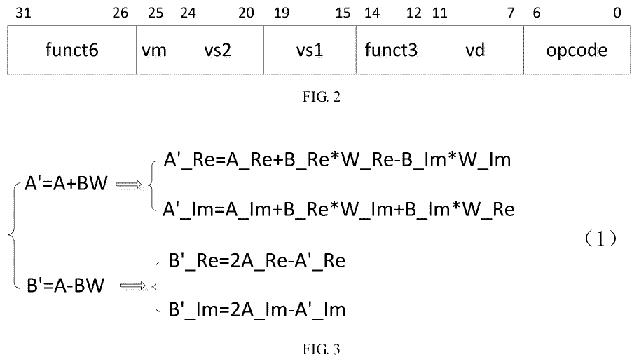

As shown in FIG. 2 which illustrates the code standard of arithmetic operation instructions of RVV1.0 and accounts for related information of operational codes and functional codes. In this embodiment, based on the standard vector structure of RVV1.0, the single-precision floating-point real sequence multiply-add extended instruction I is defined as vcfmacc.1vv in the reserved instruction code space of the RISC-V architecture, opcode=7′b101_1011 is selected as an operational code, a functional code funct3 is defined as 3′b001, a functional code funct6 is defined as 6′b10_1100, and the code format is set as vcfmacc1.vv vd, vs1, vs2, vm; the set functional codes are specifically:

for( i=0; i< vlen/2; i++) {
vd[2i]←vd[2i] + (vs1[2i+1] * vs2[2i])
vd[2i+1]←vd[2i+1] + (vs1[2i+1] * vs2[2i+1])
}

wherein, the functional codes are used for calculating odd items and even items in the complex sequence respectively, and a multiply-add operation is performed in each calculation to obtain first values of a multiply-add operation result; and the functional codes and the operational code are selected in conformity with RVV1.0.

S3: based on the standard vector structure of RVV1.0, a single-precision floating-point complex sequence multiply-add extended instruction II is defined in the reserved instruction code space of the RISC-V architecture to perform a second multiply-add operation on the data to be processed in S1 to obtain second data of the multiply-add operation of the data to be processed, and the second data and the first data obtained in S2 are added to obtain the multiply-add operation result of the data to be processed. For example, in case of a radix-2 DIT FFT butterfly operation of complex sequences A, B and W, the multiply-add operation of the complex sequences includes two stages of multiply-add operation of real numbers, the instruction I is responsible for the first stage of multiply-add operation, and the instruction II is responsible for the second stage of multiply-add operation.

Similar to the single-precision floating-point real sequence multiply-add extended instruction I, in this embodiment, based on the standard vector structure of RVV1.0, the single-precision floating-point complex sequence multiply-add extended instruction II is defined as vcfmacc.2vv in the reserved instruction code space of the RISC-V architecture, opcode=7′b101_1011 is selected as an operational code, a functional code funct3 is defined as 3′b001, a functional code funct6 is defined as 6′b10_1100, and the code format is set as vcfmacc2.vv vd, vs1, vs2, vm; the set functional codes are specifically:

for( i=0; i< vlen/2; i++) {
vd[2i]←vd[2i] + (vs1[2i] * vs2[2i+1])
vd[2i+1]←vd[2i+1] − (vs1[2i] * vs2[2i])
}

wherein, the functional codes are also used for calculating odd items and even items in the complex sequence respectively, and a multiply-add operation is performed in each calculation to obtain second values of the multiply-add operation result; the functional codes and the operational codes are selected in conformity with RVV1.0; and the first value and the second value are added to obtain the multiply-add operation result of this stage.

In this embodiment, vlen is the vector length, and if the bit width of vector registers is N and the data type is single-precision floating point, vlen is N/32. According to the functional codes of the extended instruction I and the extended instruction II, the number of cycles in the multiply-add operation is vlen/2, which is reduced by half as compared with original calculation of RVVR1.0. Therefore, the hardware logic resources required by each of the extended instruction I and the extended instruction II include N/32 floating-point multipliers and adders, which are the same as the logic resources required by the original real sequence multiply-add operation of RVV1.0, and the hardware logic resource overhead is not increased.

S4: based on the standard vector structure of RVV1.0, an immediate value vector and scalar floating-point multiply-subtract extended instruction III is defined in the reserved instruction code space of the RISC-V architecture to perform a multiply-subtract operation on the multiply-add operation result in S3 to obtain a multiply-subtract operation result of the data to be processed.

It should be noted that the multiply-add operation and the multiply-subtract operation are performed in each stage of the butterfly operation, the multiply-add operation includes more than one stage, and loop iterative operations will be performed, which is equivalent to the multiply-add operation and the multiply-subtract operation.

The vector and scalar floating-point multiply-subtract instruction in RVV1.0 is in a format: vfmsac.vf vd, rs1, vs2, vm, and functions for vd [i]←(vs2[i]*f[rs1])−vd[i]. Under the condition that the multiply-add operation result has been obtained, the multiply-subtract operation result can be obtained only by means of two vfmsac.vf instructions, and a constant needs to be loaded to rs1 in advance by means of a floating-point instruction. In some embodiments, as illustrated by the code standard in FIG. 2, this scheme eliminates the operation of loading a constant to rs1, the immediate value vector and scalar floating-point multiply-subtract extended instruction III is defined as vfmsac.vi, an immediate operand in an integer format in an instruction code is converted into a single-precision floating point, then the hardware logic of the vfmsac.vf instruction is reused, opcode=7′b101_1011 is selected as an operational code, a functional code funct3 is defined as 3′b011, a functional code funct6 is defined as 6′b10_1110, [19:15] is an imm domain, and the code format is vfmsac.vi vd, vs2, imm; the codes function for: vd[i]←(vs2[i]*imm)−vd[i].

By reusing the hardware logic resources of RVV1.0, resource overhead can be reduced, and the situation that the performance is compromised due to the addition of too many hardware is avoided. In a case where the bit width of vector registers is 256, four radix-2 FFT butterfly operation can be completed by means of the butterfly operation method in this embodiment, four vector registers are needed, and only 0.75 vector operation instruction is needed on average to implement one radix-2 FFT butterfly operation; in addition, because real parts and imaginary parts of data do not need to be separately stored in the vector registers and no extra hardware logic resource is configured, the overhead is reduced. In the invention, four vector registers and three instructions are used, and compared with the prior art where eight vector registers and at least six instructions are used, the number of program instructions is reduced by 50%, the arithmetic speed is higher, and less hardware resources are used.

In this embodiment, each instruction in the instruction system has an operational code that indicates the type of operation to be performed by the instruction, and the same operational code is selected for the three extended instructions, so these extensions can reuse the same hardware circuit in hardware implementation, thus simplifying the hardware design, improving the hardware efficiency, increasing the instruction execution speed, and satisfying the requirements of RVV1.0.

In addition, the functional codes funct of the instructions I, II and III should be set in conformity with RVV1.0, and part of these functional codes are set to be identical, and part of these functional codes are set to be different. The identical functional codes correspond to some general and basic operations, and the different functional codes are used to implement specific operations, thus avoiding conflicts caused by co-occurrence of the three instructions.

S5: the multiply-add operation result obtained in S3 and the multiply-subtract operation result obtained in S4 are added, and data obtained by adding the multiply-add operation result and the multiply-subtract operation result is stored in a vector register as an operation result of the stage. The data obtained by adding the multiply-add operation result and the multiply-subtract operation result are stored in the vector register in a form that real parts and imaginary parts of the data interleaved, that is, each piece of data is stored in the vector register in the form of a real part and an imaginary part.

The vector register, as a special register in computer hardware, can be used for storing vector data and performing vector operations. In this embodiment, the vector registers can store data of complex sequences by means of a vector load instruction and can also store data calculated in the butterfly operation, and these data stored in the vector registers can be called from the outside. For example, as shown in FIGS. 1 and 3, under the condition that data of A′ are stored in a vector register, the data of A′ can be called by means of the extended instruction III to perform the multiply-subtract operation to obtain data of B′.

In this embodiment, with the increase of the number of complex sequences to be calculated by the complex sequence FFT butterfly operation, the number of vector registers required will be greater. With a radix-2 DIT FFT butterfly operation of complex sequences as an example, as shown in FIGS. 1 and 3, A, B and W are three complex sequences, and multiply-add data of A+BW and multiply-subtract data of A-BW need to be obtained. Four vector registers are used for the three complex sequences, wherein one vector register is used for B, one vector register is used for storing a product of B and W, and the other two vector registers are used for a multiply-add operation and a multiply-subtract operation of A. It the number of the complex sequences to be calculated is more than 3, more vector registers will be used.

S6: if there is a next stage, the next stage proceeds, and S1 is performed; if there is not a next stage, the FFT butterfly operation of the complex sequences is ended. The butterfly operation is broken up into a plurality of stages, the same instructions are adopted in each stage, and calculation is sequentially performed in each stage until all operations are completed, that is, the butterfly operation is ended. An FFT butterfly operation of three complex sequences can be completed by two stages; and if more complex sequences are calculated, more stages will be needed.

One application example is given below in conjunction with FIGS. 1, 2 and 3.

A radix-2 DIT FFT butterfly operation for complex sequences A, B and W is divided into two stages. Data of A, B and W are stored in a memory, and the three complex sequences are loaded into vector registers by means of vector load instructions respectively; wherein, the complex sequence A is loaded into vector registers a1 and a2, a1 and a2 store complete data of the complex sequence A, the complex sequence B is loaded into a vector register b1, and the complex sequence W is loaded into a vector register c1.

Based on the standard vector structure of RVV1.0, three extended instructions I, II and III are defined in a reserved instruction code space of an RISC-V architecture. Wherein, the extended instructions I and II are single-precision floating-point complex sequence multiply-add extended instructions, and the extended instruction III is an immediate value vector and scalar floating-point multiply-subtract extended instruction.

The instruction I is vcfmacc.1vv, responsible for a multiply-add operation and extended from a vfmacc.vv instruction in RVV1.0; the code format of the instruction I is as follows: an operational code is custom-2(opcode=7′b101_1011), a functional code funct3 is 3′b001, a functional code funct6 is 6′b10_1100, and an instruction format is vcfmacc1.vv vd, vs1, vs2, vm; the set functional codes are specifically:

for( i=0; i< vlen/2; i++) {
vd[2i]←vd[2i] + (vs1[2i+1] * vs2[2i])
vd[2i+1]←vd[2i+1] + (vs1[2i+1] * vs2[2i+1])
}

The functional codes of the instruction I are used for calculating odd items and even items of the data respectively, the odd items correspond to real parts, and the even items correspond imaginary parts.

The instruction II is vcfmacc.2vv, also responsible for the multiply-add operation and extended from the vfmacc.vv instruction in RVV1.0; the code format of the extended instruction II is as follows: an operational code is also custom-2(opcode=7′b101_1011), a functional code funct3 is 3′b001, a functional code funct6 is 6′b10_1100, and an instruction format is vcfmacc2.vv vd, vs1, vs2, vm; the set functional codes are specifically:

for( i=0; i< vlen/2; i++) {
vd[2i]←vd[2i] + (vs1[2i] * vs2[2i+1])
vd[2i+1]←vd[2i+1] − (vs1[2i] * vs2[2i])
}

The functional codes of the instruction II are also used for calculating odd items and even items of the data respectively, the odd items correspond to real parts, and the even items correspond to imaginary parts.

The instruction III is vfmsac.vi and extended form a vfmsac.vf instruction in RVV1.0; the code format of the extended instruction III is as follows: an operational code is also custom-2(opcode=7′b101_1011), a functional code funct3 is 3′b011, a functional code funct6 is 6′b10_1110, and an instruction format is vfmsac.vi vd, vs2, imm, vm; and the codes function for: vd[i]←(vs2[i]*imm)−vd[i].

In a first stage of the butterfly operation, data of the three complex sequences are divided into odd items and even items by means of the instruction I, a multiply-add operation result of the odd items and a multiply-add operation result of the even items are calculated respectively, and the two results are used as first data; then, the data of the three complex sequences are divided into odd items and even items by means of the instruction II, and the odd items and the even items are calculated respectively to obtain two multiply-add operation results that are used as second data; the first data and the second data are added to obtain a multiply-add operation result A′ of the first stage, wherein an imaginary part of A′ is a calculation result of the even items, and a real part of A′ is a calculation result of the odd items; and then, a multiply-subtract operation is performed on A′ by means of the instruction III to obtain a multiply-subtract operation result B′ of the first stage; and the results A′ and B′ are stored in any one vector register to be used as an operation result of the first stage.

In a second stage of the butterfly operation, the operation result of the first stage is used as data to be processed, and the operation process based on the instructions I, II and III is repeated to obtain an operation result of the second stage, and the operation result of the second stage is stored in any one vector register to be used as a final result.

According to the RVV1.0 extension-based FFT butterfly operation method for complex sequences, the multiply-add operation of multiplex sequences is completed by means of two extended instructions, and the multiply-subtract operation of the complex sequences is completed by means of another extended instruction, such that the operation process is simplified, and the arithmetic speed is increased; and results of the two operations can be directly stored in vector registers, and the process of separately storing real parts and imaginary parts of data is eliminated, such that the RVV1.0 extension-based FFT butterfly operation method for complex sequences reduces hardware resource overhead and has a remarkable improvement.

The above embodiments are merely used for explaining the technical concept of the invention and are not intended to limit the protection scope of the invention. Any modifications made based on the technical concept of the invention should also fall within the protection scope of the invention.

What is claimed is:

1. An RISC-V Vector v1.0 (RVV1.0) extension-based Fast Fourier Transform (FFT) butterfly operation method for complex sequences, comprising the following steps:
S1, in one stage of an FFT butterfly operation of the complex sequences, acquiring data to be processed;
S2, based on a standard vector structure of RVV1.0, defining a single-precision floating-point complex sequence multiply-add extended instruction I in a reserved instruction code space of a Reduced Instruction Set Computing-Version Five (RISC-V) architecture to perform a multiply-add operation on the data to be processed in S1 to obtain first data;
S3, based on the standard vector structure of RVV1.0, defining a single-precision floating-point complex sequence multiply-add extended instruction II in the reserved instruction code space of the RISC-V architecture to perform a multiply-add operation on the data to be processed in S1 to obtain second data, and adding the second data and the first data obtained in S2 to obtain a multiply-add operation result of the data to be processed;
S4, based on the standard vector structure of RVV1.0, defining an immediate value vector and scalar floating-point multiply-subtract extended instruction III in the reserved instruction code space of the RISC-V architecture to perform a multiply-subtract operation on the multiply-add operation result in S3 to obtain a multiply-subtract operation result of the data to be processed;
S5, adding the multiply-add operation result obtained in S3 and the multiply-subtract operation result obtained in S4, and storing data obtained by adding the multiply-add operation result and the multiply-subtract operation result in a vector register as an operation result of the stage; and
S6, after the operation result of one stage is obtained, performing a next stage, and returning to S1 to repeat the steps until all stages of the FFT butterfly operation of the complex sequences are completed.

2. The RVV1.0 extension-based FFT butterfly operation method for the complex sequences according to claim 1, wherein a method for acquiring the data to be processed comprises:
(1) in a case where there is a previous stage, operation results in the previous stage are used as the data to be processed;
(2) in a case where there is not a previous stage, data of the complex sequences are loaded into vector registers by vector load instructions to be used as the data to be processed.

3. The RVV1.0 extension-based FFT butterfly operation method for the complex sequences according to claim 1, wherein in S2-S4, a same operational code is selected when the single-precision floating-point complex sequence multiply-add extended instruction I, the single-precision floating-point complex sequence multiply-add extended instruction II and the immediate value vector and scalar floating-point multiply-subtract extended instruction III are defined.

4. The RVV1.0 extension-based FFT butterfly operation method for the complex sequences according to claim 1, wherein in S5, the data obtained by adding the multiply-add operation result and the multiply-subtract operation result are stored in the vector register in a form that real parts and imaginary parts of the data interleaved.
